(19) United States
(12) Patent Application Publication
(10) Pub. No.: US 2011/0283176 A1
(43) Pub. Date: Nov. 17, 2011

(54) Method and device for processing and analyzing data on a personal computer

(75) Inventor: Riccardo Zulian, Bolzano Vicentino (VI) (IT)

(73) Assignee: SYNTES S.r.l., Padova (PD) (IT)

(21) Appl. No.: 12/800,528

(22) Filed: May 17, 2010

(51) Int. Cl. G06F 17/00

(52) U.S. Cl. 715/212

(57) ABSTRACT

A method and device for processing and analyzing data on a personal computer which can be implemented using software which works in a Microsoft Excel environment or as a standalone software which allows users to import, filter and/or analyze a large quantity of data in an Excel worksheet; the data can be imported from disparate sources (including text files, SQL databases and Excel files) and, once imported and stored in the computer's memory, can be displayed in a single columnar table (even if they come from different columnar tables which have disparate ordering), as well as filtered, ordered, grouped, summed and/or manipulated mathematically extremely quickly with the possibility of creating dynamic graphics and/or tables relative to various parameters; the software is compatible with Microsoft Excel 2003, Microsoft Excel 2007 and Microsoft Excel 2010 and can be used within the Windows XP, Windows Vista and Windows 7 operating systems.

The present invention relates to a method and a device for the analysis of data on a personal computer. Specifically, this invention is part of a software program which can be used as a standalone software or in conjunction with the Microsoft Excel software.

It allows users to import, filter and/or analyze large quantities of data in an Excel workbook.

Data can come from disparate sources including text files, SQL databases and Excel files.

Once the data has been imported to the primary memory of the computer, they can be represented in a columnar format, in a grid format or in a chart even if they come from sources with disparate ordering.

These data can then be grouped and filtered; it is possible to carry out calculations on the data, create dynamic graphics and tables which can be used to represent information about commercial, administrative and other business functions; time periods can be represented and compared nearly instantly.

The name of the software which is subject of the patent request is Vizubi™ and it is compatible with the Windows XP, Vista and Win7 operating systems.

It can be used in conjunction with the Microsoft Excel 2003, Excel 2007 and Excel 2010 software or as a stand-alone software.

Traditional data analysis software frequently creates obstacles for users which limit their capacity to analyze and manage data and often create confusion because of the proliferation of reports required merely to change a primary dimension.

Frequently, this software has complex interfaces which not only inhibit uptake and utilization by users, but also lead to abandonment by users.

The purpose of this invention is to remove the technical and functional obstacles created by existing data analysis tools and specifically to create a data management, analysis and presentation tool for personal computers which allows users to perform complex analyses using an interface which is easy to learn and remember.

Another purpose of this invention is to create a data management, analysis and presentation tool for personal computers which allows users to perform complex analyses on large volumes of data thorough a intuitive, highly visual graphical user interface.

Another purpose of this invention is to create a data management, analysis and presentation tool for personal computers which allows users to create analyses which can be used to quickly perform further analyses.

Another purpose of this invention is to create a data management, analysis and presentation tool for personal computers which allows users to create a methodology for analysis.

These purposes which will be more clearly defined are achieved through a device for processing and analyzing data on a personal computer according to claim 1 attached below, and a method thereof according to claim 12 attached below.

Further technical details are contained in the dependent claims which are also attached.

Advantageously, the graphical user interface used to display data allows users to create tables with huge quantities of data without having to understand the underlying data sources or the query language(s) used to query those data sources.

Other purposes of the device for data management, analysis and presentation on personal computers according to the invention will be further described and documented through preferred examples and include but are not limited to the following drawings, in which:

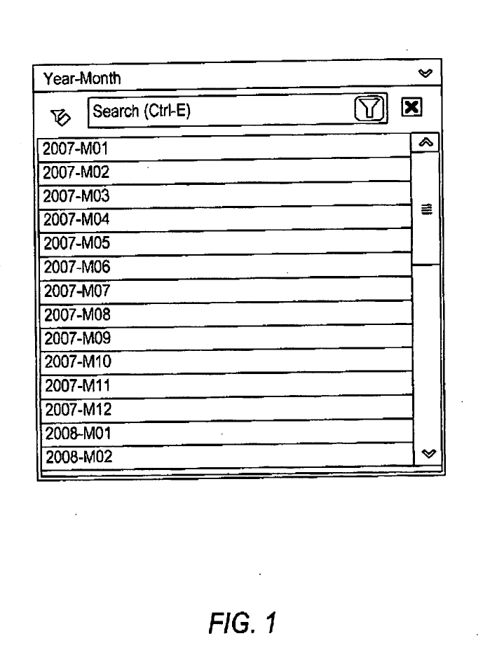

FIG. 1 shows a screen shot of one mode of visualization of the data management, analysis and presentation tool on a personal computer using this invention;

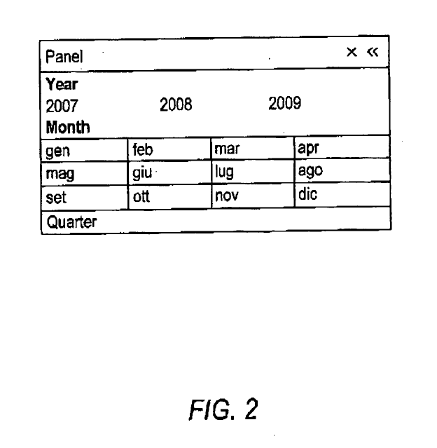

FIG. 2 shows a screen shot of a second mode of visualization of the data management, analysis and presentation tool on a personal computer using this invention;

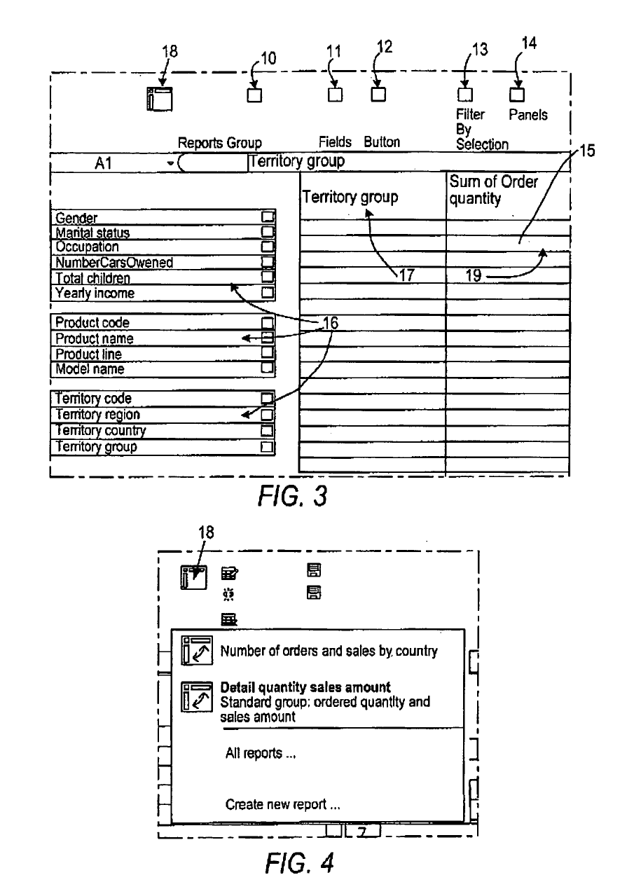

FIG. 3 shows a screen shot of the primary interface of the data management, analysis and presentation tool on a personal computer using this invention;

FIG. 4 shows a screen shot of a drop down menu of one of the main functions of the data management, analysis and presentation tool on a personal computer using this invention

FIG. 5 shows a screen shot of a drop down menu of one of the main functions and a secondary button of the data management, analysis and presentation tool on a personal computer using this invention

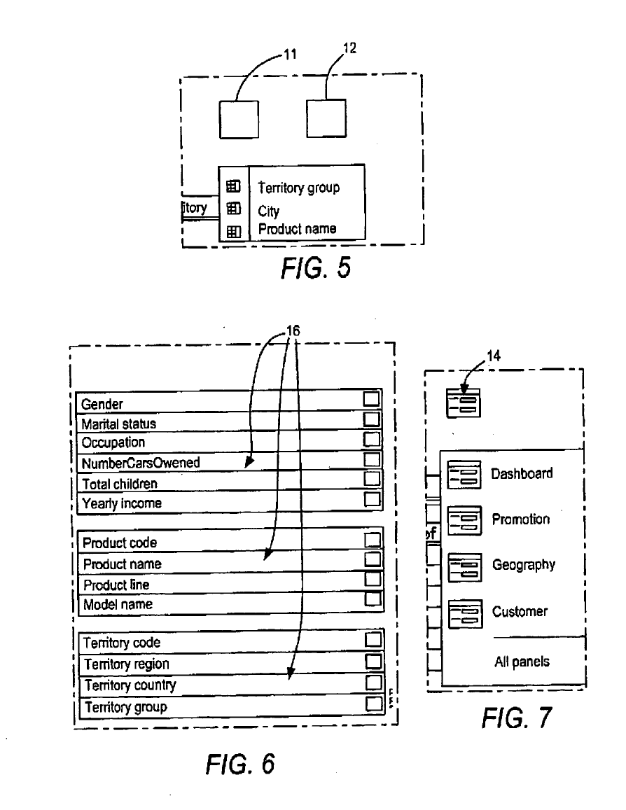

FIG. 6 shows a screen shot of part of the filtering function for analyses of the data management, analysis and presentation tool on a personal computer using this invention

FIG. 7 shows a drop down menu for the selection of the filtering function shown in FIG. 6 of the data management, analysis and presentation tool on a personal computer using this invention.

For simplicity, we assume that the data management, analysis and presentation tool on a personal computer using this invention has access to a data structure which contains information at the field level which is the most atomic level, a group or a slicer which are groups of fields, and a panel which are groups of slicers.

Fields are the most atomic level of information and generally refer to columns in a table of a relational, columnar, OLTP, OLAP or in memory database.

Each field has a “friendly name” which allows users to access the data in the field without having to know the technical names of columns in the data source.

Each field can be associated with a description which is visible to the user, as well as standard visualization formats which are list (as in FIG. 1 attached) and grid (as in FIG. 2 attached).

This allows users to access fields in the mode which is best adapted to the number of values present and personal preferences; for instance, a field which contains a few years may be shown in grid view while a long client list may be more easily viewed in list view.

Slicers are groups of one or more fields which are created by users to filter their analyses; fields can be present in multiple slicers and can come from separate tables in the database.

This allows users to simultaneously access information about products and clients for example, without having to open different tables or pass through hierarchies of data within a table to get to the desired output.

Groups are groups of one or more fields created by users for analytic purposes and are used to define the contents of a column in the place of a single field.

The interface allows users to quickly cycle through the fields in a group and change the contents of the column accordingly.

Fields can be in multiple groups.

The fields in groups can come from separate tables in the database.

This allows users to simultaneously access information about products and clients for example, without having to open different tables or pass through hierarchies of data within a table to get to the desired output.

Panels contain one or more slicers and are created by users to be able to quickly filter data; individual slicers can be contained within multiple panels.

Panels have “friendly names” which allows users to select the panel accordingly to its specific function or meaning.

In reference to FIG. 3, the main elements in the user interface are the Report button (18) in the Reports group (10), the Fields button (11) in the Group (17), the Filter Data button (12) and the Filter By Selection button (13) in the Selections group (19), the Panels button (14) the report visualization area (15) and the Panels visualization area (16).

Vizubi's graphical user interface puts all of the main elements of a report and the tools necessary to manage information in a single screen so that users can immediately see all of the information and meta-information they need to perform their analyses.

This differs radically from most “Business Intelligence” and “Reporting” tools which make users view separate tables and tabs.

The Report button (18) lets users select the tables to view; with a single click, a list of tables created by users appears (the criteria used to create this list is set by the user) along with a button which accesses the form used to generate new tables in various formats (as shown in the attached FIG. 4).

Access to all of the available reports is thus facilitated and past user behavior is used to create lists of reports users are likely to want to see.

This optimizes access in particular for occasional users who will immediately find the reports they are most likely to want to see.

The periodicity of the data used to create report lists can be set by users or a system administrator and the variables which can be set are frequency (how many times has a report been opened), date the report was last opened or used, and priority (a parameter users can associate to a report).

Users can decide how many and which parameters to set by clicking on the Report (18) button and the order and contents of the list of reports so that every report in the list is shown with its description allowing users to quickly select the report which will give them the desired output.

The Field button (11) shown in detail in FIG. 5 attached lets users quickly select the field whose values should be shown in the primary column or the user selected column of the report for columns which contain groups (as opposed to fields); the list of fields is composed by all of the available fields in the group and their order is user determined.

This button (11) allows users to change the level of grouping or the type of information shown in the report while maintaining the type of report, filters and logic constant.

By changing the level users can simulate a process of “drill down”; for instance with a group which contains the Country-Province-City-Client fields users can change the analysis to view data at the Country-Province-City-Client levels.

An analogous structure of the Group allows users to do “Drill across”; using a group with heterogeneous fields such as Product Code-Client Name-Order State, users can maintain the type of report, filters and logic while shifting the type of data shown.

For example to compare sales agents orders from last year to this year, it is possible to create a report with columns containing sales agents and sales.

Users can quickly to shift the view from agents to products, simply selecting the products field from the drop down list which appears when clicking on the Fields button (11).

Instead of creating, formatting, saving and maintaining a report for each of the fields in the group, users can create a single report with a group in it which effectively contains a plethora of reports.

Finally, each field in the list is shown with a description next to it so that even if a user has never seen a report before, they can quickly obtain the desired results.

The Filter Data button (12) changes color when filters are applied, and clicking on the button opens a window which shows which filters have been applied to the report.

If the report is set up to use pre-created filters, button 12 will show that a filter has been applied and when clicked will show the details.

If the report is set up with quick-filters, button 12 will show that and clicking on button 12 opens a list of the fields in the quick-filter.

Clicking on button 12 will always open a window with a list of all of the active filters in the report as will a “mouse-over” of that button.

The Filter by Selection button (13) lets users filter by values they select directly on the report (it is possible to use CTRL-Click to select multiple values). Using traditional tools, analyses often have to be interrupted because once the specifics of an entity have been revealed (for example clients whose purchases are below budget), it is usually necessary to reset the report with those criteria.

The interface of this invention creates a natural and simplified workflow because filters can be derived from fields on disparate tables and double-clicking on a value in any field of a report immediately applies that value as a filter (in this case without clicking on any other buttons).

The Panels button opens a list of panels which when clicked will open in the visualization panel (16) as shown in FIG. 6 attached.

Users can select which values if which fields to use as filters by selecting them from the list which appears in area (16).

Users can search for values using a simple Boolean search and then select the value(s) which correspond to their requirements.

The panel is shown in area (16) and can remain constant even if the report is modified or if a new report is opened.

Whereas other business intelligence and reporting products and require users to recreate their slicers for each report, this invention allows users to maintain the same slicers and panel while changing the underlying report.

The Panel button (14) lets users select the panel to apply; with a single click, a list of panels created by users appears (the criteria used to create this list is set by the user).

Another click will open the selected panel.

The Panel button (14) lets users access the panels they have created and creates a list of favorite panels based on past use and parameters which users set.

This lets sporadic users quickly access information they are most likely to need.

The periodicity of the data used to create panel lists can be set by users or a system administrator and the variables which can be set are frequency (how many times has a panel been opened), date the panel was last opened or used, and priority (a parameter users can associate to a panel).

Users can decide how many and which parameters to set by clicking on the Panel button (14) and the order and contents of the list of panels so that every panel in the list is shown with its description allowing users to quickly select the panel which will give them the desired output.

A typical analysis following our methodology, using this invention would consist of the following steps:
The user selects a report from the favorites or most recent reports list or the full list of reports using the Report button (18);
The report is shown in the report visualization area (15) on the PC's screen

At this point, the user can select a panel by using the Panel button (14) to filter the information and in this case:
The panel will be visualized in the panel visualization area (16) of the screen on the PC's screen
The user will select a series of values for a series of fields from within the panel which will filter the report;
The Filter Data button (12) will execute the change of state.

Alternately, the user can click on the Filter Data button (12) to modify, add or eliminate the filters on fields (and the Filter Data button will execute the change of state).

A third possibility is for the user to select values of fields directly on the report and to then click on the “Filter by Selection” button (13); the Filter Data button (12) will execute the change of state.

If the user were to select another field using the Fields button (11), the report would be instantly regenerated with the new field.

Clearly with this invention, users can quickly and easily carry out a series of analyses accessing all of the functions they need from within a single screen.

The process is intuitive and simple and results oriented.

There is no need to create multiple reports or variants of those reports which other systems require and which are difficult to create, maintain and understand.

The invention as presented may be subject to modifications and variants all contained within the concept of the invention; the details may be substituted with other technically equivalent elements; where the characteristics of the invention have been described through examples, those examples were used merely to better describe the invention and create no limitation on the interpretation of the elements described.

1. System for the management and analysis of data on a personal computer which can be implemented through a software which functions within the Microsoft Excel environment and which allows users to import, manage and analyze data within an Excel worksheet, said data being once imported from various sources and saved in the memory of the personal computer so that they are displayed on the screen of the personal computer in a single columnar table in which each column of data or field of said table is selectable and accessible to the user and can be displayed as a list, and/or grid and one or more columns of data or slicers are set up so that one or more fields are present in one or more slicers regardless of whether the fields come from the same table.

2. A system for data management and analysis as claimed in claim 1, characterized by the fact that said fields within at least one group of pre-set columns can be viewed cyclically.

3. A system for data management and analysis as claimed in claim 2, characterized by the fact that each field is present in one or more groups of fields regardless of whether they come from the same table.

4. A system for data management and analysis as claimed in claim 1, characterized by the fact that at least one panel consisting of one or more slicers can be set-up and can be selected by the user.

5. A system for data management and analysis as claimed in claim 1, characterized by the fact that said table, when selected by the user by clicking on a button (18), and visualized on the screen of the personal computer through a graphical interface, displays a visualization area (15) with a set of data or report, said report being displayed according to a set of configurable parameters including the frequency with which it was requested, the most recent date it was opened and/or used and/or its priority.

6. A system for data management and analysis as claimed in claim 5, characterized by the fact that one or more grouping levels and/or one or more types of information are displayed within the same report and are selected by the user through a button (11) on said graphical interface.

7. A system for data management and analysis as claimed in claim 5, characterized by the fact that said graphical interface includes at least one button (12) which highlights the data filtering process and/or which filters are active and with which values.

8. A system for data management and analysis as claimed in claim 5, characterized by the fact that said graphical interface includes at least one button (13) which filters the data using one or more values selected even from disparate fields.

9. A system for data management and analysis as claimed in claim 5, characterized by the fact that said graphical interface includes at least one button (14) which allows users to select a type of panel to be displayed in a specific area (16) of the screen of the personal computer.

10. A system for data management and analysis as claimed in claim 4, characterized by the fact that said panel remains unchanged even if the report is changed.

11. A system for data management and analysis as claimed in claim 9, characterized by the fact that said panel can be selected from a list whose elements are managed according to a set of configurable parameters including the frequency with which it was requested, the most recent date it was opened and/or used and/or its priority.

12. A method for data management and analysis for personal computers, characterized by the fact that it comprises at least the following steps:
selection by the user of one or more tables or reports from a pre-defined list of tables or reports;
visualization of said table or report within a first area (15) of the screen of a personal computer.

13. A method for data management and analysis as claimed in claim 12, characterized by the fact that there is a further step in which the user selects at least one panel in order to filter the data, a step in which the user views the panel in a second visualization area (16) of the screen of the personal computer, at least one selection step in which the user select one or more values from the panel to filter the data and/or at least one change of state.

14. A method for data management and analysis as claimed in claim 13, characterized by the fact that there is at least one step during which the filtering parameters are modified and/or added by the user.

15. A method for data management and analysis as claimed in claim 13, characterized by the fact that there is at least one step during which the values displayed in the report are selected by the user.
